(19) United States
(12) Patent Application Publication
(10) Pub. No.: US 2004/0213637 A1
(43) Pub. Date: Oct. 28, 2004

(54) Color coding of geotextiles and geocomposites for use in laminate structures and other geotechnical applications

(76) Inventor: Peter J. Ianniello, Havre De Grace, MD (US)

Correspondence Address: GARY L. SHAFFER, 901 BANKS PLACE, ALEXANDRIA, VA, 22312, US

(21) Appl. No.: 10/668,369

(22) Filed: Sep. 24, 2003

Related U.S. Application Data
(60) Provisional application No. 60/412,929, filed on Sep. 24, 2002.

(51) Int. Cl. E02D 17/20; B32B 19/00

(52) U.S. Cl. 405/302.7; 428/357; 405/302.6

(57) ABSTRACT

Numerous embodiments of wholly colored, partly colored and color-coded geocomposites, geotextiles and geofabrics are provided. Colored sheets, layers and laminates of the invention possess a high resistance to degradation by the effects of heat, UV and other wavelengths of light. Methods for employing the sheets, layers and laminates of the invention for shielding selected land surfaces, for providing indicators regarding the positions of one or more below-ground facilities such as utility pipes, for repelling birds, animals and insects, and for facilitating the installation of geocomposites, geotextiles and geofabrics are provided.

### CROSS-REFERENCE TO RELATED APPLICATIONS

Applicant claims all benefits of U.S. Provisional Patent Application Ser. No. 60/412,929, filed Sep. 24, 2002, which is hereby incorporated by reference.

### FIELD OF THE INVENTION

The present invention relates to geofabrics, geotextiles and geocomposites which are resistant to ultraviolet and other heat-producing radiation, and the use of pigmented, dyed or otherwise colored geofabrics, geotextiles and geocomposites and methods for using them to facilitate the sequence and proper positioning of such geo-products with respect to one another. Geofabrics, geotextiles and geocomposites of the invention afford shielding which decreases the damaging effects of heat and wind to underlying layers and surfaces, and helps to repel the unwanted activities of animals such as birds and rodents.

### BACKGROUND

Geotechnical products such as geofabrics, geotextiles and geogrids are typically formed from polymers by extrusion. The raw polymers are typically black and, therefore, the geotechnical products are typically black. In conventional methods, the installation of typical geotechnical products is intended to occur with respect to their specific and relative engineering characteristics. Because such specific and relative engineering characteristics are often not immediately observable during installation in the field, mistakes often occur that result in the malfunctioning of the installed product.

For example, in layered drainage applications, the relative position of geofabric filter layers with respect to underlying or overlying membrane layers must be correct in order for the system to maintain desired drainage capacities over time. When the relative position of the filtration layer with respect to other layers or with respect to underlying soils or surfaces is incorrect, premature clogging or other problems may occur, resulting in the premature failure of that drainage system and the consequent failure of the structure in which the drainage system is situate. Such incorrect positioning often occurs because the respective layers of a conventional geotechnical drainage system are typically all of the same color, that is, black. Although some geotechnical products may be made in non-black, that is, colors, their respective colors are not necessarily associated with key functional or engineering characteristics of the geo-product.

Thus, there is a need for geotechnical products such as geocomposites, geofabrics and geotextiles to be provided in colors which may be employed in predetermined ways to aid in the correct installation of geotechnical products. There is also a need for colored or partly colored geocomposites, geofabrics and geotextiles which have a high resistance to degradation by ultraviolet (UV) and other wavelengths of radiation.

### SUMMARY OF THE INVENTION

The present invention relates generally to the color coding of geotechnical products and more specifically to using such color coding to increase industrial efficiencies. In one aspect, the color coding provided by the present invention associates one or more particular functions or engineering characteristics of a geotechnical product with one or more preferred uses for that product. For example, geofabrics that act as filters might be colored one or more shades of orange while those that function as superior reflectors of UV and other heat-producing radiation might be colored one or more shades of white or gray. By using the color coding methods of the present invention, the key elements of a particular installation may be properly installed by workers in the field who have very little engineering background or training. In layered applications, one embodiment of the present methods includes color-coded installation instructions or placards attached to the products as they are delivered to the field. Such placards would include, for example, pictographic representations of the various colors of layers to be installed, as well as a corresponding textual description, thereby ensuring that the layers are installed in their correct positions relative to one another.

In another aspect, the present invention relates also to the use of color-coded geocomposites and geotextiles that reflect, or do not absorb, heat-producing radiation such as light, and particularly sunlight, and radiation at or near the ultraviolet (“UV”) frequencies. By reflecting UV and light of similar and/or heat-producing frequencies, the geotextiles and geocomposites of the present invention decrease the amount of heat that is absorbed by, or produced within, the geocomposites and geotextiles. In doing so, products used or positioned according to the present invention decrease the amount of heat that is transferred to, or produced within, materials that underlie the present thermally shielding geotextiles or geocomposites. By affording such protection against heat and related radiation, the present methods and products thereby decrease or eliminate the damaging effects that heat and related radiation would have on the underlying materials, and on the geotextiles or geocomposites themselves.

In still a further aspect, the present invention provides for the use of color coding to signify the degree of a particular characteristic of a geotechnical or geocomposite product. Examples of such characteristics include mechanical properties, such as tensile strength, grab tensile strength, compressive strength, puncture-resistance and trapezoidal tear strength. Color coding may be provided also to indicate the specific or relative durabilities corresponding to such engineering parameters, for example, with respect to time and with respect to their relative degree of durability.

The present invention provides a number of methods for using thermally shielding geotextiles or geocomposites to protect materials underlying them. For example, when any of the products of the present invention are used to overlie excavated or exposed soil areas such as excavated clays and humus, such as those incident to the construction of buildings, canals, waste-containment facilities, drainage ditches and the like, the temperature of the exposed areas is reduced. Thus, by using one or more of the present thermally shielding geotextiles or geocomposites, it is possible to reduce, regulate or calibrate the thermal gain that will be experienced by the underlying material. The reduction in temperature of underlying materials is beneficial to construction projects in a number of ways.

One example of such benefit pertains to the protection of cover or liner soils, such as clay, that are often used in the construction of waste containment facilities and canals. Cover clays are typically provided in layers in thicknesses of up to several inches, or even several feet. It is desirable for such clays to have a moisture content lying within a particular range in order to maximize their advantageous handling, grading and sealing characteristics. Often, clay layers are left exposed for periods of time during construction, either deliberately or by chance due to unforeseen construction schedule or weather changes. During such periods of exposure, the clays suffer desiccation effects such as cracking and powdering which typically result in additional expense to repair, add to, or replace the clay. In situations where such damaging effects are not repaired, premature failure of the structure often occurs. This is particularly so where a clay layer has a sealing function in a project like that of a waste containment facility or canal. With the present methods, the dessicating effects of heat on the underlying clay are reduced or minimized.

In one aspect, the present geotextiles and geocomposites are formed of fibers or threads having particular reflective capabilities. In a related aspect of the invention, the fibers or threads from which the present geotextiles and geocomposites are made are provided in colors. For example, blue, orange, green, gray and white. A particular geotextile or geocomposite can be made all of one color, or can be a combination of threads or fibers of various colors available in thermally-reflective or UV-resistant materials.

Materials made according to the present invention are particularly useful for combining with other geotextiles or geocomposites and may be layered with one another to form a material of appropriate thermal resistance, reflectivity, or UV resistance. Moreover, geotextiles and geofabrics of the present invention can be interwoven to produce layers having specific engineered properties such as tensile strength, grab tensile strength, compressive strength, puncture resistance and trapezoidal tear strength.

Additional aspects of the present invention include where geotextiles are provided over void-maintaining composites such as geonets, geogrids or other void-maintaining structures. In such combinations, the voids underlying the geotextiles serve to further insulate the underlying materials both thermally and with respect to dessication. These combinations provide thermal protection both by 1) providing one or more layers of geotextiles that reflect light and other heat-producing radiation, and 2) providing a gap between the geotextiles and the underlying surface. This gap serves as a transition space or void that decreases the rate of evaporation of moisture from the underlying materials. As one of skill in arts of construction or waste containment can appreciate, by decreasing such rates, the present means and methods increase the length of time in which a project can be completed without the necessity or expense of repairs to the original excavated or processed site.

In a further aspect, the present methods provide for adding moisture to one or more layers of the geotextiles or geocomposites of the invention to further increase the project completion period. Advantageously, the fibrous embodiments of geotextiles of the present means and methods can be provided in forms that have wicking rates that help regulate and control the amount and application densities of added water. Thus, a measured or regulated amount of water can be added per unit area to the geofabrics, geotextiles or geocomposites of the invention.

The present products and methods are particularly applicable to construction projects where excavated or otherwise open ground area or added soil layers may be exposed to sunlight for undesirable lengths of time. By using one or more of the present products and methods, desiccation and cracking of the underlying soil material is eliminated, minimized or reduced. Moreover, because some embodiments of the present products may be provided in colors that are matched or coded to known characteristics, their correct placement and respective properties may be easily understood by workers in the field.

Thus, the present invention includes methods for reducing the thermal absorption of materials underlying geotextiles and geocomposites by providing, among other things, geofabrics, geotextiles and geocomposites that are highly reflective of light or radiation frequencies which produce heat in materials which absorb such radiation, and methods for using alone or in combination.

### DETAILED DESCRIPTION OF THE INVENTION

It is therefore an object of the present invention to provide geocomposites, geotextiles and geofabrics which possess a high resistance to degradation by the effects of heat, UV and other wavelengths of light.

It is also an object of the invention to provide means and methods for shielding selected land surfaces, and for facilitating the installation of geocomposites, geotextiles and geofabrics.

It is a similar object of the invention to provide means and methods for indicating the positions of one or more below-ground facilities such as utility pipes, and for repelling birds, animals and insects.

In accordance with these and other objects, the present invention provides geocomposites, geotextiles and geofabrics having at least one surface comprising portions of at least one non-black color. In the context of the invention, a color is any color other than black, and white is the presence of all colors. Thus, color according to the invention can be any non-black color and especially one or more hues, shades or tints of red, orange, brown, yellow, green, blue, indigo, violet, gray, white or combinations thereof. Colored geo-composites, geotextiles and geofabrics of the invention can be multicolored or mono-chromatic. The colors can be provided in zones, such as edge zones or match zones which are colored to match a color of a succeeding or adjoining geocomposite, geotextile or geofabric.

As an additional advantage, colored geocomposites, geotextile and geofabrics the invention are provided in many forms including those which possess resistance to degradation by ultraviolet light. Among these embodiments are forms, for example, which reflect a significant portion of ultraviolet light or other heat-producing radiation which strikes them to the extent that they meet or exceed various ASTM testing and performance requirements. As is shown in Tables 1-4 herein, geotextiles and geofabrics are provided which demonstrate at least 90% resistant to UV light for 1,000 hours, or are at least 95% resistant to UV light for 500 hours in accordance with ASTM D 5261.

The resistance to degradation by ultraviolet light (UV) of geotextiles and geofabrics according to the invention adds to their durability and mechanical stability. For example, embodiments of the present geotextiles and geofabrics exhibit a durability tested under ASTM G 154 conditions of at least 90% resistance to UV light for 1,000 hours, and at least 95% resistance to UV light for 500 hours, with respect to grab tensile strength in accordance with ASTM D 4632. Resistance to puncture is also retained by the present invention.

As is shown in Tables 1-4, embodiments of geotextiles and geofabrics according to the invention exhibit durabilities when tested under ASTM G 154 of at least 90% resistance to UV light for 1,000 hours, and at least 95% resistance to UV light for 500 hours, with respect to puncture resistance in accordance with ASTM D 4833. Similar advantages are found also with respect to tear strength when tested in accordance with ASTM G 154. Specific examples of such performance is recited in Tables 1-4, and include geotextiles and geofabrics which exhibit a durability under ASTM G 154 of at least 90% resistance to UV light for 1,000 hours, and at least 95% resistance to UV light for 500 hours, with respect to trapezoidal tear strength in accordance with ASTM D 4533.

The present invention also provides numerous permutations of geocomposites, that is, a geonet core and at least one geotextile laminated or otherwise attached to, or disposed in contact with, a geonet core. Geonets suitable for creating geocomposits of the invention include any of those in use in the art, and particularly those which demonstrate void-maintaining characteristics. Examples of durable geocomposites of the invention include those comprising a geotextile which exhibits a durability under ASTM G 154 of at least 90% resistance to UV light for 1,000 hours, and those which exhibit at least 95% resistance to UV light for 500 hours, with respect to grab tensile strength in accordance with ASTM D 4632. The advantageous additional durabilities of the invention pertain also to geocomposites comprising at least one geotextile wherein the geotextile or geotextiles exhibit a durability under ASTM G 154 of at least 90% resistance to UV light for 1,000 hours with respect to trapezoidal tear strength in accordance with ASTM D 4533, at least 90% resistance to UV light for 1,000 hours with respect to puncture resistance in accordance with ASTM D 4833, and at least 90% resistance to UV light for 1,000 hours with respect to permeability in accordance with ASTM D 4491.

Similar performance characteristics are found in Tables 1-4 regarding other tests conducted in accordance with ASTM G 154 with UV light for 500 hours on embodiments of shielding geocomposites of the invention. Specifically, geotextiles useful for combining with geonet cores to form geocomposites of the invention include those wherein the geotextile exhibits a durability under ASTM G 154 of at least 95% resistance to UV light for 500 hours with respect to trapezoidal tear strength in accordance with ASTM D 4533, with respect to puncture resistance in accordance with ASTM D 4833, and with respect to permeability in accordance with ASTM D 4491.

In accordance with other objects of the invention, geocomposites, geotextiles and geofabrics of the invention are provided in colors, or with one or more portions which are colored such that they are aposematic or repellent to one or more species. Thus, in this aspect, the invention provides a measure of protection from species that otherwise might harm the geocomposites, geotextiles and geofabrics of the invention as well as the surfaces over which they are positioned. Colors suitable for use in these repelling embodiments include any color that is not black, so long as that color is repellent to one more species. Species against which the invention is effective in this regard include any that are naturally fearful of, or avoidant of, one or more colors, and those whose behavior can be modified such that they are fearful of, or avoidant of, one or more colors. Such species include, but are not limited to, mammals, birds, rodents, reptiles, amphibians, insects, ruminants, and humans. Aposematic colors include one or more hues, shades or tints of red, orange, brown, yellow, green, blue, indigo, violet, gray, white and combinations thereof. As an additional advantageous aspect, the geocomposites, geotextiles and geofabrics of the invention may further comprise one or more foul-tasting compounds which are repellent to one or more species, including but not limited to, those species listed above. Examples of such taste repellents include d-pulegone and quinine hydrochloride.

In accordance with yet additional objects of the invention, embodiments of the geocomposites, geotextiles and geofabrics of the invention include those wherein all or part of one or both of their upper surfaces are provided with one or more portions that are provided in at least one non-black color which is adapted to indicate the position of one or more buried structures. Products of the invention may thus be used to provide information regarding the position of such structures and to provide a warning to anyone digging or excavating in an area containing products of the invention. Thus, construction crews, buried facility installation crews, and utility installation and repair crews, as well as others, can be provided with warnings and indications of the positions of underground facilities such as tunnels, pipelines, electrical wires, sumps, electrical transformers, gas lines, antennae, and utility installations. In a related aspect, products of the invention may be provided in color coding schemes which correspond to standard or customized color schemes as used on diagrams, utility maps, construction prints, blueprints of below-ground utility installations. For example, in some embodiments of the invention, blue is used to indicate the nearby presence of water pipes while red is used to indicate the nearby presence of electrical cables or conduit.

The invention thus includes methods for providing indicators regarding the positions of one or more below-ground facilities. These methods comprise the steps or acts of providing one or more colored geocomposites, geotextiles or geofabrics comprising one or more portions in at least one non-black color, and installing those colored geocomposites, geotextiles or geofabrics such that the colored portions are disposed in proximity to the below-ground facilities such as to show the presence and relative placement of the facilities. Any colors may be adapted for use with the present invention including one or more hues, shades or tints of red, orange, brown, yellow, green, blue, indigo, violet, gray, white and combinations thereof.

As another advantageous aspect, the present invention also includes methods for facilitating the installation of one or more geocomposites, geotextiles and geofabrics, comprising the steps or acts of i) providing the geocomposites, geotextiles and geofabrics in one or more of the aforementioned non-black colors, ii) providing instructions adapted and arranged to show the relative placement of one or more segments of the geocomposites, geotextiles or geofabrics with respect to one another, and then iii) installing the one or more geocomposites, geotextiles or geofabrics in accordance with the provided instructions. Instructions according to this aspect of the invention can be provided by any means sutiable for conveying including, but not limited to, one or more of diagrams, charts, blueprints, plans, graphs, photographs, electronic media and computerized media such as via one or more computer networks.

Other embodiments of the present invention include a method for shielding selected land surfaces from thermal gain or dessication, comprising the steps or acts of providing at least one layer of a geocomposite, geotextile or geofabric on, onto, or in close proximity above the selected land surfaces, wherein the geocomposite, geotextile or geofabric is provided in one or more forms which reflect a significant portion of ultraviolet light and other heat-producing radiation which strikes them. Any colors may be adapted for use with the present invention including those already described herein. As a further advantage, the present method includes wherein the at least one layer is a geocomposite, the geocomposite comprising a geonet core and at least one geotextile in contact with the core, and wherein a plurality of void spaces are provided within the geonet core, and thus between the geotextile and the selected land surfaces. Among other aspects, the plurality of void spaces acts to further shield and insulate the underlying surfaces from the harmful effects of heat, desiccation, radiation and damage from animals and other species.

The means and methods of the present invention are particularly suited to selected land surfaces such as construction sites, canals, waste-containment facilities, drainage ditches, landfills, waste disposal sites, excavated or exposed soil areas such as excavated clays and humus incident to the construction of buildings and other structures, quarries, strip mines, airports, airport environs, heliports, heliport environs, temporary airports, temporary airport environs, temporary heliports and temporary heliport environs.

Additional benefits of the invention include a method for repelling one or species from selected land surfaces comprising the steps or acts of positioning on the land surface at least one layer of a geotextile, geocomposite or geofabric, wherein the geotextile, geocomposite or geofabric comprises at least one color which is aposematic to the species sought to be repelled. In a further aspect, the at least one layer may include one or more species-repelling compounds such as insecticides or insect repellents, and bird-repelling compounds.

Tables 1-4, show technical data regarding products according to the invention, including data relating to UV resistance and durabilities under various ASTM test procedures. Table 1 shows technical data regarding products according to the invention which demonstrate a 90% resistance to degradation by ultraviolet (UV) light for a period of 1,000 hours. Table 2 provides technical data regarding products according to the invention which demonstrate a 95% resistance to degradation by UV light for a period of 500 hours. Table 3 discloses technical data regarding products according to the invention which demonstrate a 90% resistance to degradation by UV light for a period of 1,000 hours. Table 4 lists technical data regarding products according to the invention which demonstrate a 95% resistance to degradation by ultraviolet light for a period of 500 hours.

TABLE 1
UV STABLE GEOTEXTILES
UV RESISANCE 90% @ 1000 Hours

| | | | | | | | | |
|---|---|---|---|---|---|---|---|---|
| Property | Test Procedure | Units | UV 516 | UV 512 | UV 510 | UV 508 | UV 507 | UV 506 |

TECHNICAL DATA

| | | | | | | | | |
|---|---|---|---|---|---|---|---|---|
| Minimum Weight | ASTM D 5261 | oz/yd² | 16 | 12 | 10 | 8 | 7 | 6 |
| | | g/m² | 542 | 407 | 339 | 271 | 237 | 203 |

MECHANICAL

| | | | | | | | | |
|---|---|---|---|---|---|---|---|---|
| Durability | ASTM G 154 | U.V. Resistance (1000 hrs) | 90% | 90% | 90% | 90% | 90% | 90% |
| Grab Tensile | ASTM D 4632 | lb | 375 | 325 | 245 | 215 | 205 | 160 |
| | | N | 1667 | 1444 | 1089 | 956 | 912 | 712 |
| Puncture Resistance | ASTM D 4833 | lb | 170 | 150 | 120 | 100 | 95 | 80 |
| | | N | 757 | 668 | 533 | 445 | 423 | 356 |
| Trapezoidal Tear | ASTM D 4533 | lb | 145 | 120 | 95 | 85 | 80 | 65 |
| | | N | 645 | 534 | 422 | 378 | 356 | 289 |

HUDRAULIC

| | | | | | | | | |
|---|---|---|---|---|---|---|---|---|
| Water Flow Rate | ASTM D 4491 | gpm/ft2 | 45 | 75 | 80 | 100 | 120 | 135 |
| | | m/s | .031 | .051 | .054 | .068 | .081 | .092 |
| Permittivity | ASTM D 4491 | sec-1 | 0.6 | 1.0 | 1.1 | 1.3 | 1.6 | 1.8 |
| Permeability, Kv | ASTMD 4491 | cm/sec | 0.2 | 0.3 | 0.3 | 0.3 | 0.3 | 0.3 |
| A.O.S. | ASTM 4751 | sieve size | 100 | 80 | 80 | 70 | 70 | 70 |
| | | mm | .150 | .180 | .180 | .212 | .212 | .212 |

PACKAGING

| | | | | | | | |
|---|---|---|---|---|---|---|---|
| Width | ft | 15 | 15 | 15 | 15 | 15 | 15 |
| | m | 4.6 | 4.6 | 4.6 | 4.6 | 4.6 | 4.6 |
| Length | ft | 300 | 300 | 300 | 300 | 300 | 300 |
| | m | 91.4 | 91.4 | 91.4 | 91.4 | 91.4 | 91.4 |
| Area | yd² | 500 | 500 | 500 | 500 | 500 | 500 |
| | m² | 418 | 418 | 418 | 418 | 418 | 418 |
| Weight Per Roll | lb | 540 | 408 | 343 | 277 | 244 | 211 |
| | kg | 245 | 185 | 156 | 126 | 111 | 96 |

TABLE 2
UV STABLE GEOTEXTILES
UV RESISANCE 90% @ 500 Hours

| | | | | | | | | |
|---|---|---|---|---|---|---|---|---|
| Property | Test Procedure | Units | UV 516 | UV 512 | UV 510 | UV 508 | UV 507 | UV 506 |

TECHNICAL DATA

| | | | | | | | | |
|---|---|---|---|---|---|---|---|---|
| Minimum Weight | ASTM D 5261 | oz/yd² | 16 | 12 | 10 | 8 | 7 | 6 |
| | | g/m² | 542 | 407 | 339 | 271 | 237 | 203 |

MECHANICAL

| | | | | | | | | |
|---|---|---|---|---|---|---|---|---|
| Durability | ASTM G 154 | U.V. Resistance (500 hrs) | 95% | 95% | 95% | 95% | 95% | 95% |
| Puncture Resistance | ASTM D 4833 | lb | 170 | 150 | 120 | 100 | 95 | 80 |
| | | N | 757 | 668 | 533 | 445 | 423 | 356 |
| Trapezoidal Tear | ASTM D 4533 | lb | 145 | 120 | 95 | 85 | 80 | 65 |
| | | N | 645 | 534 | 422 | 378 | 356 | 289 |
| Grab Tensile | ASTM D 4632 | lb | 375 | 325 | 245 | 215 | 205 | 160 |
| | | N | 1667 | 1444 | 1089 | 956 | 912 | 712 |

HYDRAULIC

| | | | | | | | | |
|---|---|---|---|---|---|---|---|---|
| Water Flow Rate | ASTM D 4491 | gpm/ft2 | 45 | 75 | 80 | 100 | 120 | 135 |
| | | m/s | .031 | .051 | .054 | .068 | .081 | .092 |
| Permittivity | ASTM D 4491 | sec-1 | 0.6 | 1.0 | 1.1 | 1.3 | 1.6 | 1.8 |
| Permeability, Kv | ASTM D 4491 | cm/sec | 0.2 | 0.3 | 0.3 | 0.3 | 0.3 | 0.3 |
| A.O.S. | ASTM 4751 | sieve size | 100 | 80 | 80 | 70 | 70 | 70 |
| | | mm | .150 | .180 | .180 | .212 | .212 | .212 |

PACKAGING

| | | | | | | | |
|---|---|---|---|---|---|---|---|
| Width | ft | 15 | 15 | 15 | 15 | 15 | 15 |
| | m | 4.6 | 4.6 | 4.6 | 4.6 | 4.6 | 4.6 |
| Length | ft | 300 | 300 | 300 | 300 | 300 | 300 |
| | m | 91.4 | 91.4 | 91.4 | 91.4 | 91.4 | 91.4 |
| Area | yd² | 500 | 500 | 500 | 500 | 500 | 500 |
| | m² | 418 | 418 | 418 | 418 | 418 | 418 |
| Weight Per Roll | lb | 540 | 408 | 343 | 277 | 244 | 211 |
| | kg | 245 | 185 | 156 | 126 | 111 | 96 |

TABLE 3
UV STABLE BI-PLANAR GEOCOMPOSITES
UV RESISTANCE 90% @ 1000 Hours

| | TEST | | | | | | | | | |
|---|---|---|---|---|---|---|---|---|---|---|
| PROPERTIES | METHOD | UNIT | UVB1106 | UVB1105 | | UVB1086 | UVB1085 | | UVB1066 | UVB1065 |
| GEONET CORE | | | | | | | | | | |
| Tensile Strength - | ASTM D 5035 | ppi (kN/m) | 90 (16) | 48 (8.4) | . . . | 90 (16) | 48 (8.4) | . . . | 90 (16) | 48 (8.4) |
| MD | | | | | | | | | | |
| Thickness | ASTM D 5199 | mil (mm) | 250 (6.4) | 200 (5.1) | | 250 (6.4) | 200 (5.1) | | 250 (6.4) | 200 (5.1) |
| Compressive Creep⁶ | ASTM D 1621 | | In accordance with GC-8 | | | | | | | |
| GEOTEXTILE | | | | | | | | | | |
| Apparent Opening | ASTM D 4751 | US Std. Sieve | 80 (0.18) | 80 (0.18) | | 70 (0.212) | 70 (0.212) | | 70 (0.212) | 70 (0.212) |
| Size (AOS) | | (mm) | | | | | | | | |
| Weight | ASTM D 5261 | oz/yd2 (g/m2) | 10 | 10 | | 8 | 8 | | 6 | 6 |
| Water Flow Rate | ASTM D 4491 | gpm/ft2 | 80 (3260) | 80 (3260) | | 100 (4075) | 100 (4075) | | 135 (5500) | 135 (5500) |
| | | (lpm/m2) | | | | | | | | |
| Permeability | ASTM D 4491 | cm/sec | 0.3 | 0.3 | | 0.3 | 0.3 | | 0.3 | 0.3 |
| Puncture Strength | ASTM D 4833 | lbs (N) | 120 (533) | 120 (533) | | 100 (444) | 100 (444) | | 80 (356) | 80 (356) |
| Trapezoid Tear | AST D 4533 | lbs (N) | 95 (422) | 95 (422) | | 85 (378) | 85 (378) | | 65 (289) | 65 (289) |
| Grab Tensile | ASTM D 4632 | lbs (N) | 245 (1089) | 245 (1089) | | 215 (956) | 215 (956) | | 160 (711) | 160 (711) |
| Strength | | | | | | | | | | |
| UV Resistance @ | ASTM G 154 | % | 90 | 90 | | 90 | 90 | | 90 | 90 |
| 1000 Hours | | | | | | | | | | |
| GEOCOMPOSITE | | | | | | | | | | |
| Roll Width | | ft (m) | 14 (4.27) | 14 (4.27) | | 14 (4.27) | 14 (4.27) | | 14 (4.27) | 14 (4.27) |
| Roll Length | | ft (m) | 225 (68.6) | 225 (68.6) | | 225 (68.6) | 225 (68.6) | | 225 (68.6) | 225 (68.6) |
| Ply Adhesion² | ASTM F904 | lb/in (g/in) | 1.0 (454) | 1.0 (454) | | 1.0 (454) | 1.0 (454) | | 1.0 (454) | 1.0 (454) |
| | (modified) | | | | | | | | | |
| Geotextile Overlap | | in(mm) | 3 (75) | 3 (75) | | 3 (75) | 3 (75) | | 3 (75) | 3 (75) |
| at edges | | | | | | | | | | |
| and unbonded area | | | | | | | | | | |
| HYDRAULIC | | | | | | | | | | |
| BEHAVIOR OF | | | | | | | | | | |
| GEOCOMPOSITE | | | | | | | | | | |

| | |
|---|---|
| Performance | In accordance with GC-8 |
| Transmissivity | |

TABLE 4
UV STABLE-BIPLANAR DRAINAGE GEOCOMPOSITES
UV RESISTANCE 95% @ 500 Hours

| | TEST | | | | | | | | | |
|---|---|---|---|---|---|---|---|---|---|---|
| PROPERTIES | METHOD | UNIT | UVB5106 | UVB5105 | | UVB5086 | UVB5085 | | UVB5066 | UVB5065 |
| GEONET CORE | | | | | | | | | | |
| Tensile Strength - | ASTM D 5035 | ppi (kN/m) | 90 (16) | 48 (8.4) | . . . | 90 (8.4) | 48 (8.4) | . . . | 90 (16) | 48 (8.4) |
| MD | | | | | | | | | | |
| Thickness | ASTM D 5199 | Mil (mm) | 250 (6.4) | 200 (5.1) | | 250 (6.4) | 200 (5.1) | | 250 (6.4) | 200 (5.1) |
| Compressive Creep⁵ | GRI-GS4 | | In accordance with GC-8 | | | | | | | |
| GEOTEXTILE | | | | | | | | | | |
| Apparent Opening | ASTM D 4751 | US Std. Sieve | 80 (0.18) | 80 (0.18) | | 70 (0.212) | 70 (0.212) | | 70 (0.212) | 70 (0.212) |
| Size (AOS) | | (mm) | | | | | | | | |
| Weight | ASTM D 5261 | oz/yd2(g/m2) | 10 | 10 | | 8 | 8 | | 6 | 6 |
| Water Flow Rate | ASTM D 4491 | Gpm/ft2 (lpm/ | 80 (3260) | 80 (3260) | | 100 (4075) | 100 (4075) | | 135 (5500) | 135 (5500) |
| | | m2) | | | | | | | | |
| Permeability | ASTM D 4491 | cm/sec | 0.3 | 0.3 | | 0.3 | 0.3 | | 0.3 | 0.3 |
| Puncture Strength | ASTM D 4833 | lbs (N) | 120 (533) | 120 (533) | | 100 (444) | 100 (444) | | 80 (356) | 80 (356) |
| Trapezoid Tear | ASTM D 4533 | lbs (N) | 95 (422) | 95 (422) | | 85 (378) | 85 (378) | | 65 (289) | 65 (289) |
| Grab Tensile | ASTM D 4632 | lbs (N) | 245 (1089) | 245 (1089) | | 215 (956) | 215 (956) | | 160 (711) | 160 (711) |
| Strength | | | | | | | | | | |
| UV Resistance @ | ASTM G 154 | % | 95 | 95 | | 95 | 95 | | 95 | 95 |
| 500 Hours | | | | | | | | | | |
| GEOCOMPOSITE | | | | | | | | | | |
| Roll Width | | ft (m) | 14 (4.27) | 14 (4.27) | | 14 (4.27) | 14 (4.27) | | 14 (4.27) | 14 (4.27) |
| Roll Length | | ft (m) | 225 (68.6) | 225 (68.6) | | 225 (68.6) | 225 (68.6) | | 225 (68.6) | 225 (68.6) |
| Ply Adhesion² | ASTM F904 | lb/in (g/in) | 1.0 (454) | 1.0 (454) | | 1.0 (454) | 1.0 (454) | | 1.0 (454) | 1.0 (454) |
| HYDRAULIC | | | | | | | | | | |
| BEHAVIOR OF | | | | | | | | | | |
| GEOCOMPOSITE | | | | | | | | | | |

| | |
|---|---|
| Performance | In accordance with GC-8 |
| Transmissivity | |

Although the present disclosure generally describes the present invention and includes specific examples, these examples are presented to illustrate, and not to limit, the scope and spirit of the invention. As a review of the description and data provided herein demonstrates, there are permutations of embodiments of the means and methods of the invention which are too numerous to specifically list. Nonetheless, these numerous permutations are within the scope and comprehension of the invention.

What is claimed is:

1. A geocomposite, geotextile or geofabric having at least one surface comprising portions of at least one non-black color.

2. The geocomposite, geotextile or geofabric of claim 1, wherein said non-black color is one or more hues, shades or tints of red, orange, brown, yellow, green, blue, indigo, violet, gray, white or combinations thereof.

3. The geocomposite, geotextile or geofabric of claim 1, wherein said non-black color is monochromatic.

4. The geocomposite, geotextile or geofabric of claim 1, wherein said geocomposite, geotextile or geofabric is provided in one or more forms which possess resistance to degradation by ultraviolet light.

5. The geocomposite, geotextile or geofabric of claim 1, wherein said geocomposite, geotextile or geofabric is provided in one or more forms which reflect a significant portion of ultraviolet light or other heat-producing radiation which strikes them.

6. A geotextile or geofabric according to claim 4, wherein said geotextile or geofabric is at least 90% resistant to UV light for 1,000 hours in accordance with ASTM D 5261.

7. A geotextile or geofabric according to claim 4, wherein said geotextile or geofabric is at least 95% resistant to UV light for 500 hours in accordance with ASTM D 5261.

8. A geotextile or geofabric according to claim 4, wherein said geotextile or geofabric exhibits a durability under ASTM G 154 of at least 90% resistance to UV light for 1,000 hours with respect to grab tensile strength in accordance with ASTM D 4632.

9. A geotextile or geofabric according to claim 4, wherein said geotextile or geofabric exhibits a durability under ASTM G 154 of at least 95% resistance to UV light for 500 hours with respect to grab tensile strength in accordance with ASTM D 4632.

10. A geotextile or geofabric according to claim 4, wherein said geotextile or geofabric exhibits a durability under ASTM G 154 of at least 90% resistance to UV light for 1,000 hours with respect to puncture resistance in accordance with ASTM D 4833.

11. A geotextile or geofabric according to claim 4, wherein said geotextile or geofabric exhibits a durability under ASTM G 154 of at least 95% resistance to UV light for 500 hours with respect to puncture resistance in accordance with ASTM D 4833.

12. A geotextile or geofabric according to claim 4, wherein said geotextile or geofabric exhibits a durability under ASTM G 154 of at least 90% resistance to UV light for 1,000 hours with respect to trapezoidal tear strength in accordance with ASTM D 4533.

13 A geotextile or geofabric according to claim 4, wherein said geotextile or geofabric exhibits a durability under ASTM G 154 of at least 95% resistance to UV light for 500 hours with respect to trapezoidal tear strength in accordance with ASTM D 4533.

14. A geocomposite according to claim 1, said geocomposite comprising a geonet core and at least one geotextile in contact with said core,
wherein said geotextile exhibits a durability under ASTM G 154 of at least 90% resistance to UV light for 1,000 hours with respect to grab tensile strength in accordance with ASTM D 4632.

15. A geocomposite according to claim 1, said geocomposite comprising a geonet core and at least one geotextile in contact with said core,
wherein said geotextile exhibits a durability under ASTM G 154 of at least 95% resistance to UV light for 500 hours with respect to grab tensile strength in accordance with ASTM D 4632.

16. A geocomposite according to claim 1, said geocomposite comprising a geonet core and at least one geotextile in contact with said core,
wherein said geotextile exhibits a durability under ASTM G 154 of at least 90% resistance to UV light for 1,000 hours with respect to trapezoidal tear strength in accordance with ASTM D 4533.

17. A geocomposite according to claim 1, said geocomposite comprising a geonet core and at least one geotextile in contact with said core,
wherein said geotextile exhibits a durability under ASTM G 154 of at least 95% resistance to UV light for 500 hours with respect to trapezoidal tear strength in accordance with ASTM D 4533.

18. A geocomposite according to claim 1, said geocomposite comprising a geonet core and at least one geotextile in contact with said core,
wherein said geotextile exhibits a durability under ASTM G 154 of at least 90% resistance to UV light for 1,000 hours with respect to puncture resistance in accordance with ASTM D 4833.

19. A geocomposite according to claim 1, said geocomposite comprising a geonet core and at least one geotextile in contact with said core,
wherein said geotextile exhibits a durability under ASTM G 154 of at least 95% resistance to UV light for 500 hours with respect to puncture resistance in accordance with ASTM D 4833.

20. A geocomposite according to claim 1, said geocomposite comprising a geonet core and at least one geotextile in contact with said core,
wherein said geotextile exhibits a durability under ASTM G 154 of at least 90% resistance to UV light for 1,000 hours with respect to permeability in accordance with ASTM D 4491.

21. A geocomposite according to claim 1, said geocomposite comprising a geonet core and at least one geotextile in contact with said core,
wherein said geotextile exhibits a durability under ASTM G 154 of at least 95% resistance to UV light for 500 hours with respect to permeability in accordance with ASTM D 4491.

22. The geocomposite, geotextile or geofabric of claim 1, wherein said portions of at least one non-black color are aposematic to one or more species.

23. The geocomposite, geotextile or geofabric of claim 22, wherein said one or more species is selected from the group consisting of birds, rodents, reptiles, amphibians, insects, ruminants, and humans.

24. The geocomposite, geotextile or geofabric of claim 1, further comprising one or more taste repellents which are repellent to one or more species selected from the group consisting of birds, rodents, reptiles, amphibians, insects, ruminants, and humans.

25. The geocomposite, geotextile or geofabric of claim 24, wherein said taste repellents comprise one or more from the group consisting of d-pulegone and quinine hydrochloride.

26. The geocomposite, geotextile or geofabric of claim 1, wherein said portions of at least one non-black color correspond to the color coding scheme of below-ground utility installations.

27. A method for providing indicators regarding the positions of one or more below-ground facilities comprising the steps or acts of
A) providing one or more of geocomposites, geotextiles and geofabrics comprising one or more portions in at least one non-black color,
B) installing said colored portions of said one or more colored geocomposites, geotextiles or geofabrics in proximity to said below-ground facilities such as to show the presence and relative placement of said facilities.

28. The method of claim 27, wherein said one or more below-ground facilities is selected from the group consisting of pipelines, electrical wires, sumps, electrical transformers, gas lines, antennae, and utility installations.

29. The method of claim 27, wherein said one at least one non-black color is one or more hues, shades or tints of red, orange, brown, yellow, green, blue, indigo, violet, gray, white or combinations thereof.

30. A method for facilitating the installation of one or more of geocomposites, geotextiles and geofabrics, comprising the steps or acts of
A) providing said geocomposites, geotextiles and geofabrics in one or more non-black colors,
B) providing instructions adapted and arranged to show the relative placement of one or more segments of said geocomposites, geotextiles or geofabrics with respect to one another, and
C) installing said one or more geocomposites, geotextiles or geofabrics in accordance with said instructions.

31. The method of claim 30, wherein said instructions are provided in one or more forms from the group consisting of diagrams, charts, blueprints, plan, graphs, photographs and electronic media.

32. The method of claim 31, wherein said instructions are provided via one or more computer networks.

33. A method for of shielding selected land surfaces from thermal gain or dessication, comprising the step or act of
providing at least one layer of a geocomposite, geotextile or geofabric on or in close proximity above said selected land surfaces, wherein said geocomposite, geotextile or geofabric is provided in one or more forms which reflect a significant portion of ultraviolet light and other heat-producing radiation which strikes them.

34. The method of claim 33, wherein said at least one layer is provided in at least one non-black color selected from one or more hues, shades or tints of red, orange, brown, yellow, green, blue, indigo, violet, gray, white or combinations thereof.

35. The method of claim 33, wherein said at least one layer is a geocomposite, said geocomposite comprising a geonet core and at least one geotextile in contact with said core, and
wherein a plurality of void spaces are provided within said geonet core and between said geotextile and said selected land surfaces.

36. The method of claim 33, wherein said selected land surfaces are one or more selected from the group consisting of construction sites, canals, waste-containment facilities, drainage ditches, landfills, waste disposal sites, excavated or exposed soil areas such as excavated clays and humus incident to the construction of buildings and other structures, quarries, strip mines, airports, airport environs, heliports, heliport environs, temporary airports, temporary airport environs, temporary heliports and temporary heliport environs.

37. A method for repelling one or more species from selected land surfaces comprising the step or act of
positioning on said one or more selected land surfaces, at least one layer of a geotextile, geocomposite or geofabric, wherein said layer comprises at least one color which is aposematic to the species sought to be repelled.

38. The method of claim 37, wherein said at least one layer comprises one or more species-repelling compounds such as insecticides, insect repellents and bird-repelling compounds.
